(19) United States
(12) Patent Application Publication
(10) Pub. No.: US 2008/0056601 A1
(43) Pub. Date: Mar. 6, 2008

(54) Image Processing Device and Method

(75) Inventor: Mamoru Kitamura, Niigata (JP)

Correspondence Address: PATENTTM.US, P. O. BOX 82788, PORTLAND, OR, 97282-0788, US

(73) Assignees: Kikin Yugengaisha Takahara, Chuo-shi, Ehime (JP); NIIGATA SEIMITSU CO., LTD., Joetsu-shi, Niigata (JP)

(21) Appl. No.: 11/575,207

(22) PCT Filed: Sep. 26, 2005
(86) PCT No.: PCT/JP05/17584

§ 371 Date: Mar. 13, 2007

(30) Foreign Application Priority Data
Oct. 29, 2004 (JP) 2004-315635

(51) Int. Cl. G06K 9/40

(52) U.S. Cl. 382/266

(57) ABSTRACT

Image processing device and method wherein processing is simplified. The image processing device is provided with line memories 320, 322, 324 for storing image data composed of brightness data of a plurality of pixels constituting an image, a control circuit 334, an address generating circuit 326 and the like for reading out brightness data of 3×3 pixels, which is 9 pixels in total, having a target pixel at the center, among the stored brightness data, and a brightness-data calculating circuit 332 for calculating new brightness data corresponding to the target pixel after image quality adjustment by using the read out brightness data of the 9 pixels.

### TECHNICAL FIELD

The present invention relates to an image processing device and method for applying image processing such as edge enhancement to image data inputted.

### BACKGROUND ART

Conventionally, there is known an edge enhancement device that extracts an edge of an image from image data inputted by means of using an edge filter, applying gain adjustment to this edge, and then adding the edge to the original image data thereby enhance the edge of the image (see, for example, a Patent Document 1). By using this edge enhancement device, it is possible to enhance an edge included in an image while changing a degree of gain adjustment to adjust a degree of edge enhancement.

[Patent Document 1] Japanese Patent Laid-Open No. 2001-292325 (pages 3 to 11 and FIGS. 1 to 11)

### DISCLOSURE OF THE INVENTION

In the edge enhancement device disclosed in the Patent Document 1 described above, it is necessary to apply three kinds of arithmetic operations, namely, (1) extraction of an edge, (2) gain adjustment, and (3) addition of an edge portion, to image data inputted. Thus, there is a problem in that processing is complicated.

The invention has been devised in view of such a point and it is an object of the invention to provide an image processing device and method that are capable of simplifying processing.

In order to solve the problem, an image processing device according to the invention includes an image-data storing unit that stores image data including pixel data of a plurality of pixels constituting an image, a pixel-data readout unit that reads out pixel data of 3×3 pixels, i.e., nine pixels in total, having a target pixel at the center from the image data stored in the image-data storing unit, and a pixel-data calculating unit that calculates new image data after image quality adjustment is performed corresponding to the target pixel with using the pixel data of the nine pixels read out by the pixel-data readout unit.

An image processing method according to the invention includes a step of reading out pixel data of 3×3 pixels, i.e., nine pixels in total, having a target pixel at the center from image data including pixel data of a plurality of pixels constituting an image and a step of calculating new pixel data after image quality adjustment is performed corresponding to the target pixel with using the pixel data of the nine pixels read out.

Consequently, it is possible to perform image quality adjustment processing such as edge enhancement simply by extracting nine pixels including a target pixel and calculating new pixel data corresponding to the target pixel using pixel data of the nine pixels. This makes it unnecessary to perform complicated processing, for example, performing extraction of an edge and gain adjustment and then adding the edge to the original pixel data, and makes it possible to simplify processing.

It is desirable that, when pixel data of two first pixels adjacent to a target pixel along an identical horizontal line are D and F, the pixel-data calculating unit applies image quality adjustment processing to the target pixel by adding a value proportional to an added value of these pixel data D and F to pixel data E of the target pixel. Alternatively, it is desirable that, when pixel data of two first pixels adjacent to a target pixel along an identical horizontal line are D and F, in the step of calculating new pixel data, image quality adjustment processing is applied to the target pixel by adding a value proportional to an added value of these pixel data D and F to pixel data E of the target pixel. This makes it possible to perform image quality adjustment processing with an influence due to the pixels adjacent to the target pixel in the horizontal direction reflected on the pixel data of the target pixel.

It is desirable that, when pixel data of two second pixels that correspond to two horizontal lines adjacent to the target pixel and are adjacent to the target pixel in the vertical direction with respect to the horizontal lines are B and H, the pixel-data calculating unit applies image quality adjustment processing to the target pixel by adding a value proportional to an added value of these pixel data B and H to pixel data E of the target pixel. Alternatively, it is desirable that, when pixel data of two second pixels that correspond to two horizontal lines adjacent to a target pixel and are adjacent to the target pixel in the vertical direction with respect to the horizontal lines are B and H, in the step of calculating new pixel data, image quality adjustment processing is applied to the target pixel by adding a value proportional to an added value of these pixel data B and H to pixel data E of the target pixel. This makes it possible to perform image quality adjustment processing with an influence due to the pixels adjacent to the target pixel in the vertical direction reflected on the pixel data of the target pixel.

It is desirable that, when pixel data of four third pixels that correspond to two horizontal lines adjacent to the target pixel and are adjacent to the target pixel in oblique directions are A, C, G, and I, the pixel-data calculating unit applies image quality adjustment processing to the target pixel by adding a value proportional to an added value of these pixel data A, C, G, and I to pixel data E of the target pixel. Alternatively, it is desirable that, when pixel data of four third pixels that correspond to two horizontal lines adjacent to a target pixel and are adjacent to the target pixel in oblique directions are A, C, G, and I, in the step of calculating new pixel data, image quality adjustment processing is applied to the target pixel by adding a value proportional to an added value of these pixel data A, C, G, and I to pixel data E of the target pixel. This makes it possible to perform image quality adjustment processing with an influence due to the pixels adjacent to the target pixel in the oblique directions reflected on the pixel data of the target pixel.

It is desirable that enhance processing along a direction in which the pixels to which the added value is added and the target pixel are arranged abreast is performed by setting a proportional constant in calculating the value proportional to the added value to a negative value. By setting the proportional constant to a negative value, it is possible to realize an enhance effect for enhancing an edge portion included in an image.

It is desirable that blurring processing along a direction in which the pixels to which the added value is added and the target pixel are arranged abreast is performed by setting a proportional constant in calculating the value proportional to the added value to a positive value. By setting the proportional constant to a positive value, it is possible to realize a blurring effect for averaging an edge portion included in an image.

It is desirable that the proportional constant is an adjustment parameter, a value of which is changeable, and the image processing device further includes an adjustment-parameter setting unit that variably sets the value of the adjustment parameter. Alternatively, it is desirable that the proportional constant is an adjustment parameter, a value of which is changeable, and the image processing method further includes a step of variably setting the value of the adjustment parameter. This makes it possible to variably set degrees of the enhance effect and the blurring effect.

It is desirable that the pixel-data calculating unit adjusts a value of pixel data for image quality adjustment according to the value of the adjustment parameter set by the adjustment-parameter setting unit. This makes it possible to easily obtain, simply by changing the value of the adjustment parameter, pixel data with degrees of the enhance effect and the blurring effect adjusted.

It is desirable that the pixel-data calculating unit multiplies pixel data of one pixel by a weighting coefficient indicated by an impulse response waveform indicating an influence of the one pixel on peripheral pixels around the one pixel and calculates new pixel data corresponding to the target pixel by associating an influence of the adjacent pixels on the target pixel with the one pixel. Also, it is desirable that the weighting coefficients that make the influence of the one pixel on the peripheral pixels different are individually set for a partial area of the peripheral pixels and for a remaining area other than the partial area by the impulse response waveform. This makes it possible to finely set a degree of the influence of the one pixel on the peripheral pixels arranged around the one pixel.

It is desirable that, as the weighting coefficient, a positive value corresponds to the partial area close to the one pixel is set and a negative value corresponds to the remaining area distant from the one pixel is set. This makes it possible to impart a negative area to an impulse response in the same manner as a general sampling function for performing interpolation processing among data and obtain a more natural image after image quality adjustment with the degree of the influence of the one pixel on the peripheral pixels accurately reflected thereon.

It is desirable that the image processing device further includes a weighting-coefficient setting unit that variably sets the weighting coefficient. This makes it possible to variably set a degree of image quality adjustment.

It is desirable that it is possible to individually set the impulse response waveform according to a relative positional relation of the peripheral pixels to the one pixel. This makes it possible to perform, when contents of an image have directivity (e.g., depending on a direction that an edge faces), image quality adjustment processing with the direction reflected thereon.

It is desirable that it is possible to individually set the weighting coefficient indicated by the impulse response waveform for a case in which the peripheral pixels are adjacent to the one pixel along a horizontal line, a case in which the peripheral pixels are adjacent to the one pixel to the horizontal line in the vertical direction, and a case in which the peripheral pixels are adjacent to the one pixel in the oblique directions with respect to the horizontal line. This makes it possible to adjust degrees of enhancement and blurring depending on which of the horizontal, vertical and oblique directions a direction that a color and a shade of an image change is along.

### BRIEF DESCRIPTION OF THE DRAWINGS

FIG. 1 is a diagram showing an overall configuration of an image processing device according to a first embodiment;

FIG. 2 is a diagram showing operation timing of a serial-parallel conversion circuit and a timing adjusting circuit;

FIG. 3 is a diagram showing a configuration of an image-quality adjusting circuit;

FIG. 4 is a diagram showing a detailed configuration of a brightness-data processing section;

FIG. 5 is a diagram showing an example of a configuration of a switch circuit;

FIG. 6 is a diagram showing a relation between an arrangement of nine pixels to be subjected to the image quality adjustment processing and brightness data Y;

FIG. 7 is a diagram showing a degree of an influence of one pixel affects on eight pixels arranged around the one pixel;

FIG. 8 is a diagram showing an impulse response waveform indicating a degree of an influence in the horizontal direction;

FIG. 9 is a diagram showing an impulse response waveform indicating a degree of an influence in the vertical direction;

FIG. 10 is a diagram showing an impulse response waveform indicating a degree of an influence in the oblique direction;

FIG. 11 is a diagram showing a degree of an influence of left and right pixels adjacent to a center pixel in the horizontal direction on the center pixel;

FIG. 12 is a diagram showing a degree of an influence on a center pixel by upper and lower pixels adjacent to the center pixel in the vertical direction;

FIG. 13 is a diagram showing a degree of an influence on a center pixel by pixels in corner parts adjacent to the center pixel in oblique directions;

FIG. 14 is a diagram showing a detailed configuration of a brightness-data calculating circuit;

FIG. 15 is a diagram showing a relation between image quality adjustment parameters and enhance effects;

FIG. 16 is a diagram showing a relation between image quality adjustment parameters and enhance effects;

FIG. 17 is a diagram showing a relation between image quality adjustment parameters and enhance effects;

FIG. 18 is a diagram showing a configuration of an image processing device according to a second embodiment;

FIG. 19 is a flowchart showing an operation procedure of the image quality adjustment processing by the image processing device.

### DESCRIPTION OF SYMBOLS

1, 2 image processing devices
100 serial-parallel conversion circuit
200 timing adjusting circuit
300 image-quality adjusting circuit
302 adjustment-parameter setting section
310 brightness-data processing section
312, 314 color-difference-data processing sections
320, 322, 324 line memories
326 address generating circuit
328 switch circuit
330 brightness data buffer
332 brightness-data calculating circuit
334 control circuit
350-368 adders
374-390 multipliers
392 divider
400 parallel-serial conversion circuit
500 CPU
502 ROM
504 RAM
506 hard disk device (HD)
508 Video RAM (VRAM)
510 display processing section
512 display
520 operation section
530 communication processing section
540 scanner

### MODE FOR CARRYING OUT THE INVENTION

Image processing devices according to an embodiment to which the invention is applied will be hereinafter explained in detail.

### First Embodiment

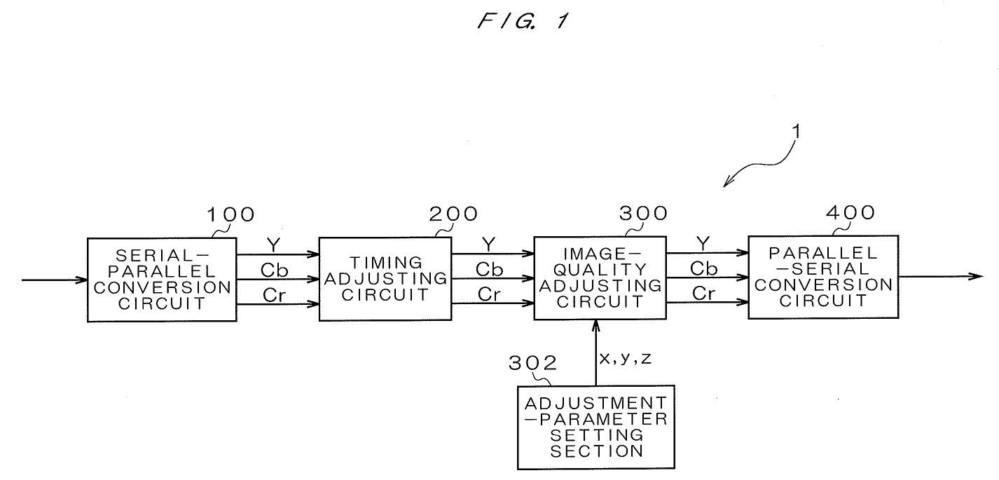

FIG. 1 is a diagram showing an overall configuration of an image processing device according to a first embodiment. An image processing device 1 shown in FIG. 1 includes a serial-parallel conversion circuit 100, a timing adjusting circuit 200, an image-quality adjusting circuit 300, an adjustment-parameter setting section 302, and a parallel-serial conversion circuit 400. This image processing device 1 is inputted with video data of a predetermined number of bits (e.g., 8 bits) in a format conforming to ITU-R.BT601-5/656, performs image quality adjustment processing using this video data, and then outputs video data of the same format. The image processing device 1 is built in or externally attached to a television receiver and a monitor apparatus that perform video display using the video data of the format or a disk recorder/player and a videoplayer that provide the television receiver and the monitor apparatus with the video data.

When brightness data Y and color difference data Cb and Cr constituting the video data of the above format are serially inputted in a predetermined order, the serial-parallel conversion circuit 100 separates the brightness data Y and the color difference data Cb and Cr, and outputs the data in parallel. For example, the respective data are constituted by 8 bits. The timing adjusting circuit 200 adjusts output timing of the brightness data Y and the color difference data Cb and Cr outputted from the serial-parallel conversion circuit 100 in parallel.

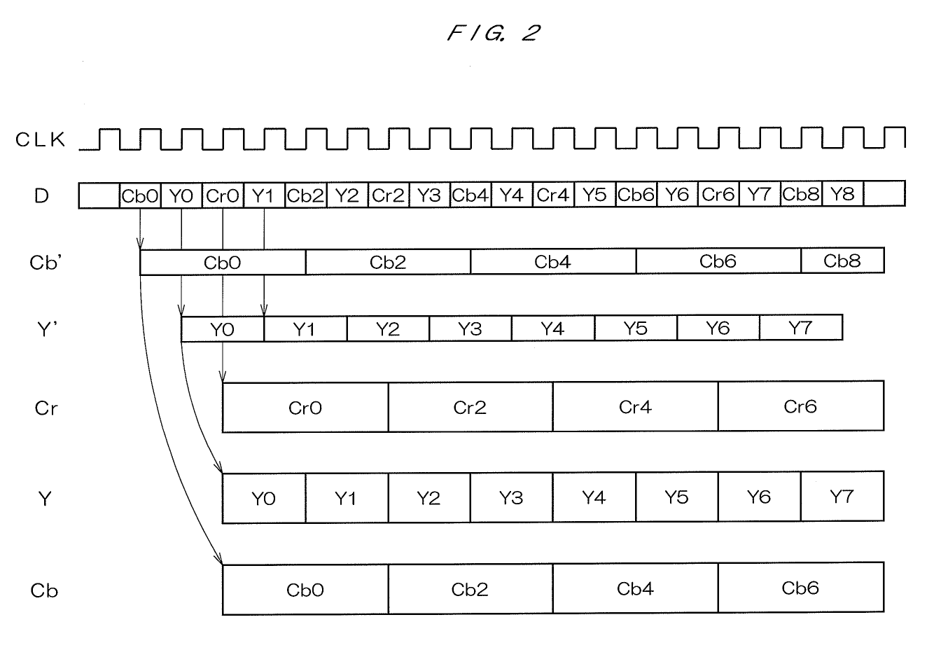

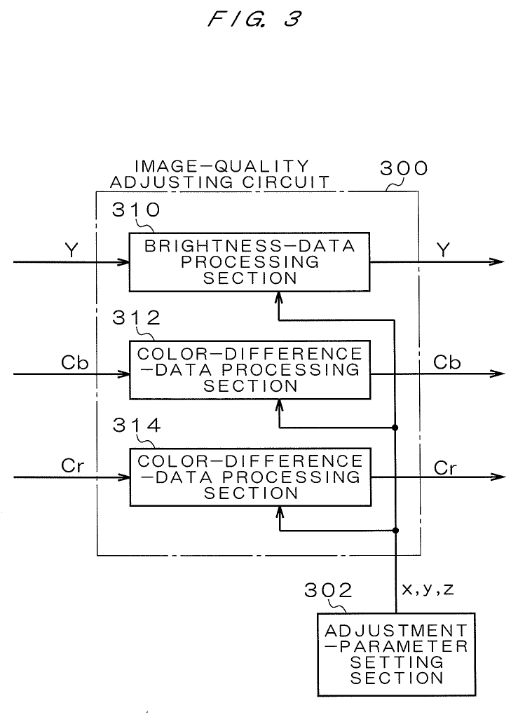

FIG. 2 is a diagram showing operation timing of the serial-parallel conversion circuit 100 and the timing adjusting circuit 200. As shown in FIG. 2, video data D is inputted in synchronization with a predetermined clock CLK in an order of the color difference data Cb, the brightness data Y, the color difference data Cr, and the brightness data Y. One color difference data Cb or Cr is associated with two brightness data Y to constitute video data. It is conceivable that the clock CLK is extracted from video data inputted or supplied from a device at a pre-stage separately from the video data.

The serial-parallel conversion circuit 100 extracts and separates color difference data Cb′, brightness data Y′, and color difference data Cr at rising timing of the clock CLK and outputs these data at different timing. The timing adjusting circuit 200 adjusts output timing of the color difference data Cb and the brightness data Y to coincide with output timing of the color difference data Cr. In this embodiment, the output timing of the color difference data Cb and the brightness data Y is adjusted to the output timing of the color difference data Cr. However, output timing of each of the color difference data Cb and Cr and the brightness data Y may be adjusted to timing later than the output timing of the color difference data Cr.

The image-quality adjusting circuit 300 performs image processing for adjusting an image quality using the brightness data Y and the color difference data Cb and Cr outputted from the timing adjusting circuit 200. This image processing is performed individually for each of the brightness data Y and the color difference data Cb and Cr. The brightness data Y and the color difference data Cb and Cr after image quality adjustment are outputted in parallel. It is possible to change a degree of image quality adjustment (a degree of image quality enhancement or blurring) by changing a value of an adjustment parameter. Processing for setting the value of the adjustment parameter in a predetermined range is performed by the adjustment-parameter setting unit 302. For example, when a user operates an operation unit including an operation switch and an operation dial, a signal indicating contents of the operation is sent to the adjustment-parameter setting unit 302. The adjustment-parameter setting unit 302 sets, according to the contents of the operation by the user, a parameter “x” for performing image quality adjustment concerning the horizontal direction (a scanning direction) of a video to be displayed, an image quality adjustment parameter “y” concerning the vertical direction of the video, and an image quality adjustment parameter “z” concerning oblique directions of the video. Details of these three parameters “x”, “y”, and “z” will be described later.

The parallel-serial conversion circuit 400 generates video data of a format conforming to ITU-R.BT601-5/656 on the basis of the brightness data Y and the color difference data Cb and Cr after image quality adjustment outputted from the image-quality adjusting circuit 300 in parallel and outputs the video data. In this way, the image processing device 1 applies image quality adjustment processing to the video data inputted and outputs a video signal of the same format after image quality adjustment.

Details of the image-quality adjusting circuit 300 will be explained. FIG. 3 is a diagram showing a configuration of the image-quality adjusting circuit 300. As shown in FIG. 3, the image-quality adjusting circuit 300 includes a brightness-data processing section 310 and color-difference-data processing sections 312 and 314 corresponding to the brightness data Y and the color difference data Cb and Cr inputted, respectively. The brightness-data processing section 310 applies image quality adjustment processing corresponding to the set parameters “x”, “y”, and “z” to the brightness data Y inputted. The color-difference-data processing section 312 applies image quality adjustment processing corresponding to the set parameters “x”, “y”, and “z” to the color difference data Cb inputted. The color-difference-data processing section 314 applies image quality adjustment processing corresponding to the set parameters “x”, “y”, and “z” to the color difference data Cr inputted. Since the brightness data Y twice as many as the color difference data Cb and Cr are inputted as described above, processing speed for the brightness-data processing section 310 is set to speed twice as high as processing speed for the color difference data Cb and Cr. For example, a frequency f_{Y} of an operation clock of the brightness-data processing section 310 is set to a frequency twice as high as that of an operation clock f_{C} of the color-difference-data processing sections 312 and 314.

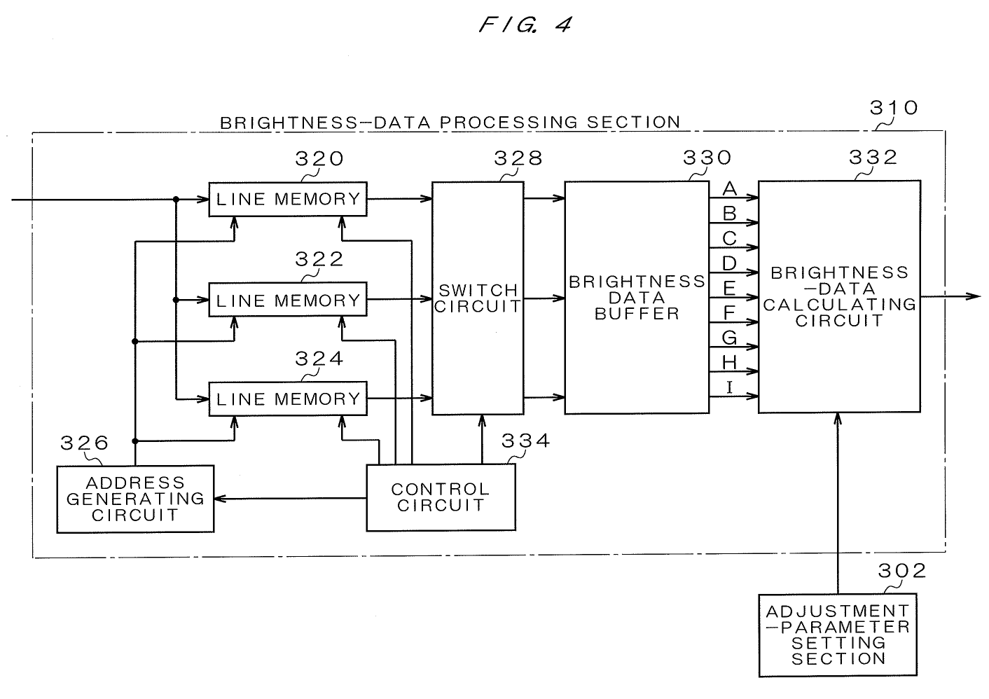

FIG. 4 is a diagram showing a detailed configuration of the brightness-data processing section 310. As shown in FIG. 4, the brightness-data processing section 310 includes three line memories 320, 322, and 324, an address generating circuit 326, a switch circuit 328, a brightness data buffer 330, a brightness-data calculating circuit 332, and a control circuit 334. The color-difference-data processing sections 312 and 314 have the same configuration as the brightness-data processing section 310 (the brightness data buffer 330 is replaced with a color-difference-data buffer and the brightness-data calculating circuit 332 is replaced with a color-difference-data calculating circuit). Detailed explanations of the color-difference-data processing sections 312 and 314 are omitted.

Each of the line memories 320, 322, and 324 stores the brightness data Y of one horizontal line inputted in a scanning order. For example, the brightness data Y of one line inputted first is stored in the line memory 320. The brightness data Y of one line inputted next is stored in the line memory 322. The brightness data Y of one line inputted next is stored in the line memory 324. When the brightness data Y of the fourth line is inputted after the brightness data Y of the three lines are inputted in this way, the brightness data Y of the fourth line is stored in the line memory 320. In this way, the brightness data Y of the latest three lines are always stored in these three line memories 320, 322, and 324.

The address generating circuit 326 generates a writing address and a readout address of the line memories 320, 322, and 324. The address generating circuit 326 updates a value of the writing address in synchronization with timing when the brightness data Y is inputted and inputs this writing address to any one of the line memories 320, 322, and 324 that are set as writing objects of the brightness data Y at that point. In the line memory 320 and the like, the brightness data Y is stored in a storage area specified by the writing address inputted. The readout address generated by the address generating circuit 326 is simultaneously inputted to the three line memories 320, 322, and 324. The image quality adjustment processing according to this embodiment is performed using the brightness data Y of three pixels in the horizontal direction and three pixels in the vertical direction, i.e., nine pixels in total. Thus, the same readout address is simultaneously inputted to the three line memories 320, 322, and 324 in order to simultaneously read out the brightness data Y of pixels in the same horizontal position.

The switch circuit 328 performs rearrangement of the brightness data Y simultaneously read out from the three line memories 320, 322, and 324. For example, when attention is paid to the inputted brightness data Y of three lines from the beginning, the brightness data Y of one line inputted last is stored in the line memory 324, the brightness data Y of one line inputted before last is stored in the line memory 322, and the oldest brightness data Y of one line is stored in the line memory 320. In general, a scanning order is set in the horizontal direction from the upper left of a screen of a monitor apparatus or the like. Thus, the brightness data Y of three pixels of an upper line in 3×3 pixels to be subjected to the image quality adjustment processing, the brightness data Y of three pixels of a center line, and the brightness data Y of three pixels of a lower line are stored in the line memory 320, the line memory 322, and the line memory 324, respectively. However, since the brightness data Y of the fourth line is overwritten in the line memory 320, it is necessary to shift a relation between the upper line, the center line, and the lower line of 3×3 pixels to be subjected to the image quality adjustment processing and the line memories 320, 322, and 324 by one line. This processing is performed by the switch circuit 328.

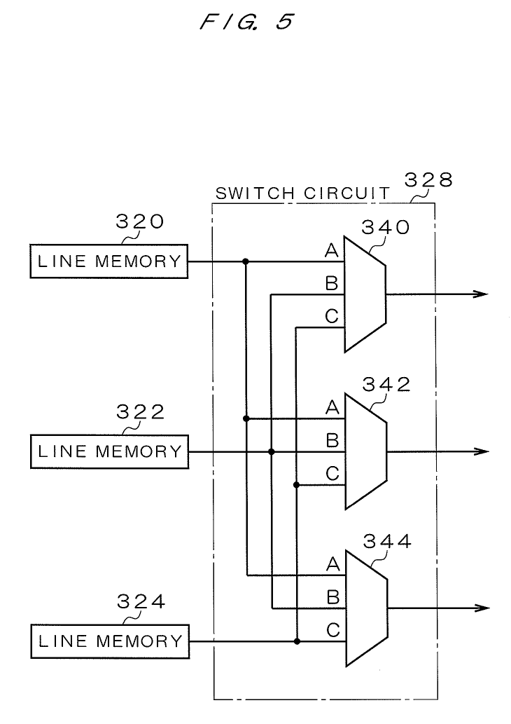

FIG. 5 is a diagram showing an example of a configuration of the switch circuit 328. In the example shown in FIG. 5, the switch circuit 328 includes three selectors 340, 342, and 344. Each of the selectors 340, 342, and 344 has three input terminals A, B, and C. The brightness data Y read out from the line memory 320 is inputted to the input terminal A. The brightness data Y read out from the line memory 322 is inputted to the input terminal B. The brightness data Y read out from the line memory 324 is inputted to the input terminal C. The selector 340 performs selection of line memories in an order of the input terminals A, B, C, A, . . . and selectively outputs the brightness data Y read out from a line memory having an earliest scanning order. The selector 342 performs selection of line memories in an order of the input terminals B, C, A, B, . . . and selectively outputs the brightness data Y read out from a line memory having a second earliest scanning order. The selector 344 performs selection of line memories in an order of the input terminals C, A, B, C, . . . and selectively outputs the brightness data Y read out from a line memory having a latest scanning order.

The brightness data buffer 330 stores the brightness data Y of 3×3 pixels read out from the three line memories 320, 322, and 324 via the switch circuit 328. The brightness-data calculating circuit 332 calculates brightness data after image quality adjustment corresponding to a center pixel (a target pixel) on the basis of the brightness data of nine pixels stored in the brightness data buffer 330. The control circuit 334 instructs the address generating circuit 326 to generate a readout address and a writing address and sends an enable signal to one or all of the line memories 320, 322, and 324 to control a writing operation or a readout operation for brightness data. The control circuit 334 performs control for switching a selection state in each of the selectors constituting the switch circuit 328.

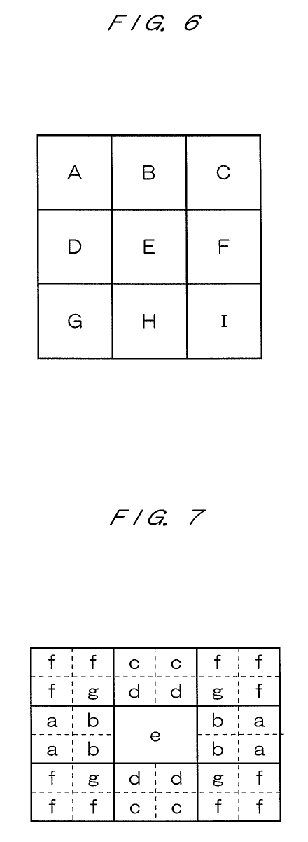

Details of the image quality adjustment processing will be explained. FIG. 6 is a diagram showing a relation between an arrangement of nine pixels to be subjected to the image quality adjustment processing and the brightness data Y. Brightness data of three pixels arranged in an upper line are A, B, and C in order from the left, brightness data of three pixels arranged in a center line are D, E, and F in order from the left, and brightness data of three pixels arranged in a lower line are G, H, and I in order. The brightness data of a center pixel is changed from E to E′ according to the image quality adjustment processing.

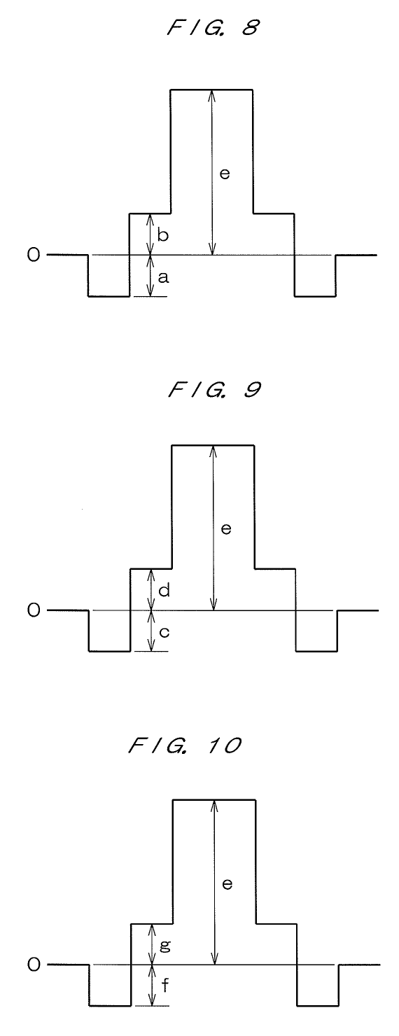

FIG. 7 is a diagram showing a degree of an influence of one pixel affects on eight pixels arranged around the one pixel. FIG. 8 is a diagram showing an impulse response waveform indicating a degree of an influence in the horizontal direction. As shown in FIG. 8, when a weighting coefficient corresponding to a target pixel is “e”, a weighting coefficient of half areas (partial areas) on an adjacent side of pixels adjacent to the target pixel in the horizontal direction is set to “b” and a weighting coefficient of another half areas (remaining areas) on a counter-adjacent side is set to “a”. It is possible to adjust a degree of an influence of the center pixel affecting on the pixels adjacent to the center pixel in the horizontal direction by adjusting values of these weighting coefficients “a”, “b”, and “e”

FIG. 9 is a diagram showing an impulse response waveform indicating a degree of an influence in the vertical direction. As shown in FIG. 9, when a weighting coefficient corresponding to a target pixel is “e”, a weighting coefficient of half areas (partial areas) on an adjacent side of pixels adjacent to the target pixel in the vertical direction is set to “d” and a weighting coefficient of another half areas (remaining areas) on a counter-adjacent side is set to “c”. It is possible to adjust a degree of an influence of the center pixel on the pixels adjacent to the center pixel in the vertical direction by adjusting values of these weighting coefficients “c”, “d”, and “e”.

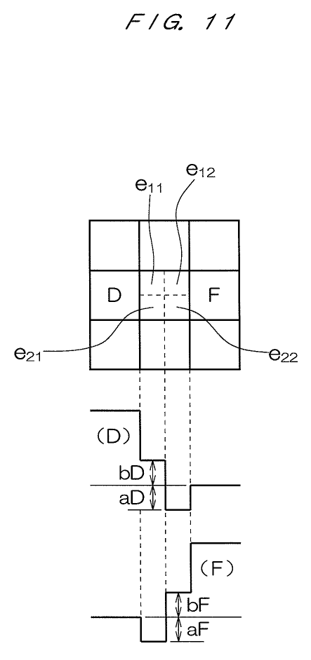

FIG. 10 is a diagram showing an impulse response waveform indicating a degree of an influence in oblique directions. As shown in FIG. 10, when a weighting coefficient corresponding to a target pixel is “e”, a weighting coefficient of ¼ areas (partial areas) on an adjacent side of pixels adjacent to the target pixel in the oblique directions is set to “g” and a weighting coefficient of ¾ areas (remaining areas) on a counter-adjacent side is set to “f”. It is possible to adjust a degree of an influence of the center pixel on the pixels adjacent to the center pixel in the oblique direction by adjusting values of these weighting coefficients “f”, “g” and “e”.

In the explanations using FIGS. 7 to 10, the influence of the center pixel on the pixels around the center pixel is considered. However, in order to calculate brightness data E after image quality adjustment of the center pixel, on the contrary, it is necessary to consider an influence of the peripheral pixels on the center pixel.

FIG. 11 is a diagram showing a degree of an influence of left and right pixels adjacent to a center pixel in the horizontal direction on the center pixel. It is possible to calculate a degree of an influence of adjacent pixels on the center pixel according to the impulse response waveform shown in FIG. 8. A degree bD of an influence on a left half area of the center pixel is obtained by multiplying brightness data D of an adjacent pixel by the weighting coefficient “b”. A degree aD of an influence on a right half area of the center pixel is obtained by multiplying brightness data D of the adjacent pixel by the weighting coefficient “a”.

The same applies to a case in which attention is paid to an adjacent pixel on the right side. A degree aF of an influence on the left half area of the center pixel is obtained by multiplying brightness data F of the adjacent pixel by the weighting coefficient “a”. A degree bF of an influence on the right half area of the center pixel is obtained by multiplying the brightness data F of the adjacent pixel by the weighting coefficient “b”.

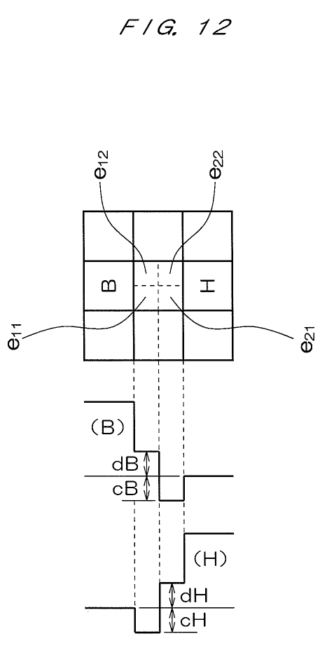

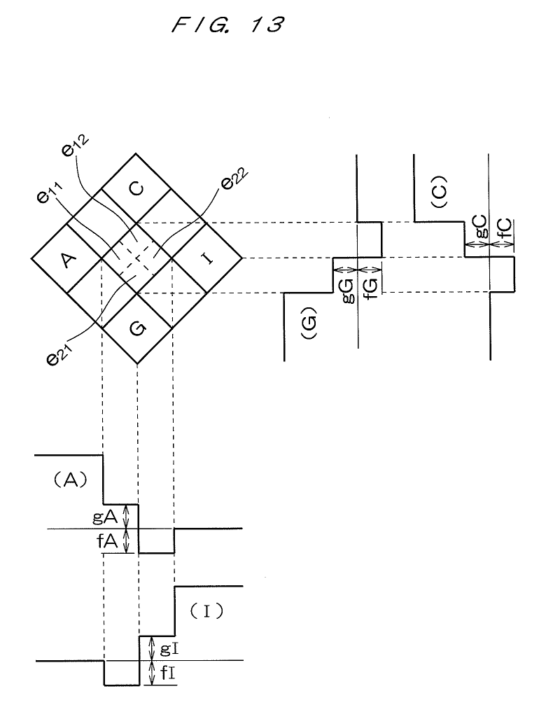

FIG. 12 is a diagram showing a degree of an influence on a center pixel by upper and lower pixels adjacent to the center pixel in the vertical direction. It is possible to calculate a degree of an influence of the adjacent pixels on the center pixel according to the impulse response waveform shown in FIG. 9. A degree dB of an influence on an upper half area of the center pixel is obtained by multiplying brightness data B of an adjacent pixel by the weighting coefficient “d”. A degree cB of an influence on a lower half area of the center pixel is obtained by multiplying the brightness data B of the adjacent pixel by the weighting coefficient “c”.

The same applies to a case in which attention is paid to an adjacent pixel on the lower side. A degree cH of an influence on the upper half area of the center pixel is obtained by multiplying brightness data H of the adjacent pixel by the weighting coefficient “c”. A degree dH of an influence on the lower half area of the center pixel is obtained by multiplying the brightness data H of the adjacent pixel by the weighting coefficient “d”.

FIG. 13 is a diagram showing a degree of an influence on a center pixel by pixels in corner parts adjacent to the center pixel in oblique directions. It is possible to calculate a degree of an influence of the adjacent pixels on the center pixel according to the impulse response waveform shown in FIG. 10. A degree gA of an influence on an upper left ¼ area of the center pixel is obtained by multiplying brightness data A of an adjacent pixel by the weighting coefficient “g”. A degree fA of an influence on a ¾ area excluding the upper left ¼ area of the center pixel is obtained by multiplying the brightness data A of the adjacent pixel by the weighting coefficient “f”.

The same applies to a case in which attention is paid to an adjacent pixel on the upper right. A degree fC of an influence on a ¾ area excluding an upper right ¼ area of the center pixel is obtained by multiplying brightness data C of the adjacent pixel by the weighting coefficient “f”. A degree gC of an influence on the upper right ¼ area of the center pixel is obtained by multiplying the brightness data C of the adjacent pixel by the weighting coefficient “g”.

A degree gG of an influence on a lower left ¼ area of the center pixel is obtained by multiplying brightness data G of an adjacent pixel by the weighting coefficient “g”. A degree fG of an influence on a ¾ area excluding the lower left ¼ area of the center pixel is obtained by multiplying the brightness data G of the adjacent pixel by the weighting coefficient “f”.

A degree fI of an influence on a ¾ area excluding a lower right ¼ area of the center pixel is obtained by multiplying brightness data I of an adjacent pixel by the weighting coefficient “f”. A degree gI of an influence on the lower right ¼ area of the center pixel is obtained by multiplying the brightness data I of the adjacent pixel by the weighting coefficient “g”.

Considering all the results described above, brightness data E11 of the upper left ¼ area of the target pixel, brightness data E12 of the upper right ¼ area of the target pixel, brightness data E21 of the lower left ¼ area of the target pixel, and brightness data E22 of the lower right ¼ area of the target pixel are as described below.
E11=(eE+gA+dB+fC+bD+aF+fG+cH+fI)/e (1)
E12=(eE+fA+dB+gC+aD+bF+fG+cH+fI)/e (2)
E21=(eE+fA+cB+fC+bD+aF+gG+dH+fI)/e (3)
E22=(eE+fA+cB+fC+aD+bF+fG+dH+gI)/e (4)

A coefficient of 1/e in each of equations (1) to (4) is a coefficient for adjusting an average value of brightness data not to fluctuate before and after image quality adjustment.

An actual center pixel has one area as a whole rather than being divided into four areas as described above. Thus, as described below, brightness data E′ after image quality adjustment is obtained by averaging the brightness data E11, E12, E21, and E22 of the respective areas calculated according to equations (1) to (4).

$$\begin{matrix}{E}^{′} = ( E 11 + E 12 + E 21 + E 22 ) / 4 e \\ = ( 4 e E + ( 3 f + g ) ( A + C + G + I ) + \\ 2 ( c + d ) ( B + H ) + 2 ( a + b ) ( D + F ) ) / 4 e\end{matrix} \qquad ( 4 )$$

where, when 3f+g=z, c+d=y, and a+b=x,
E′=(4eE+z(A+C+G+I)+2y(B+H)+2x(D+F))/4e (5)
“x”, “y”, and “z” are image quality adjustment parameters. Values of “x”, “y”, and “z” are set by the adjustment-parameter setting section 302. In equation (5), when “x”, “y”, and “z” are set as x=0, y=0, and z=0, the brightness data E′ after image quality adjustment=E, which is equivalent to a case in which the image quality adjustment processing is not performed at all. In order to prevent this, “x”, “y”, and “z” only have to be set as x≠0, y≠0, and z≠0. When values of “x”, “y”, and “z” are positive, a blurring effect is obtained rather than an enhance effect (an edge enhance effect). Therefore, when it is desired to obtain the enhance effect, it is necessary to set values of “x”, “y”, and “z” to negative values. In the following explanation, details in obtaining the enhance effect will be explained. The same idea applies to a case in which the blurring effect is obtained. When values of “x”, “y”, and “z” are set to values other than 0, a gain of the brightness data E′ fluctuates as these values are variably set. Thus, brightness data E″ normalized by a sum M(=x+y+z) of coefficients is set as an image quality adjustment result.
E″=(4eE+z(A+C+G+I)+2y(B+H)+2x(D+F))/4eM (6)

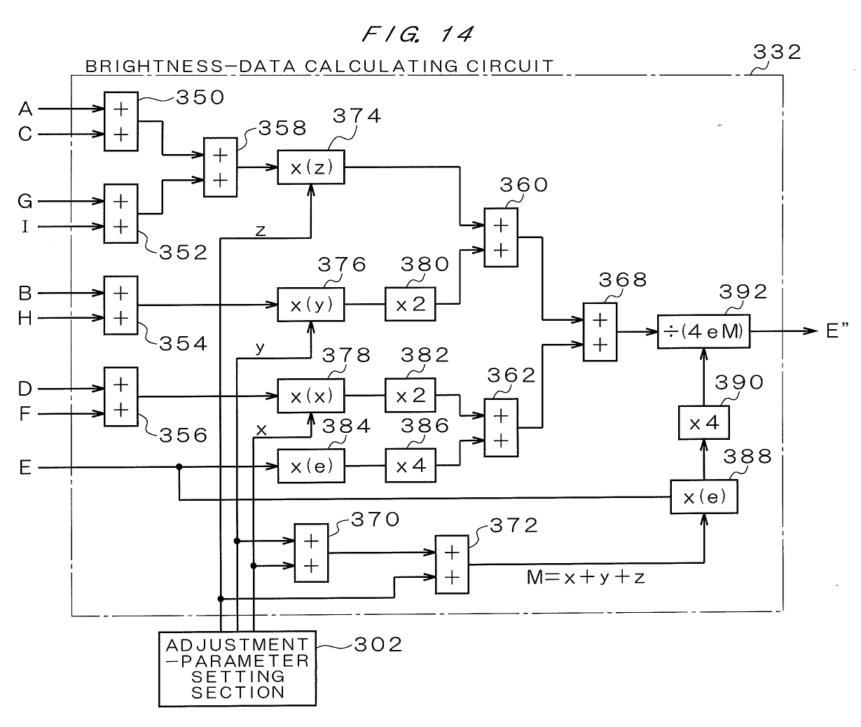

The brightness-data calculating circuit 332 performs the image quality adjustment processing by performing the calculation of the contents indicated by equation (6). FIG. 14 is a diagram showing a detailed configuration of the brightness-data calculating circuit 332. The brightness-data calculating circuit 332 includes ten adders 350 to 368, nine multipliers 374 to 390, and one divider 392.

The multiplier 384 has a multiplier factor set to “e”, multiplies the brightness data E inputted by “e”, and outputs the result. The multiplier 386 has a multiplier factor set to 4, multiplies an output (eE) of the multiplier 384 by 4, and outputs the result. In this way, a term of “4eE” included in equation (6) is calculated.

The adder 350 adds the brightness data A and the brightness data C inputted. The adder 352 adds the brightness data G and the brightness data I inputted. The adder 358 adds an output (A+C) of the adder 350 and an output (G+I) of the adder 352. The multiplier 374 has a multiplier factor set to the image quality adjustment parameter “z” outputted from the adjustment-parameter setting section 302, multiplies an output (A+C+G+I) of the adder 358 by “z”, and outputs the result. In this way, a term of “z(A+C+G+I)” included in equation (6) is calculated.

The adder 354 adds the brightness data B and the brightness data H inputted. The multiplier 376 has a multiplier factor set to the image quality adjustment parameter “y” outputted from the adjustment-parameter setting section 302, multiplies an output (B+H) of the adder 354 by “y”, and outputs the result. The multiplier 380 has a multiplier factor set to 2, multiplies an output (y(B+H)) of the multiplier 376, and outputs the result. In this way, a term of “2y(B+H)” included in equation (6) is calculated.

The adder 356 adds the brightness data D and the brightness data F inputted. The multiplier 378 has a multiplier factor set to the image quality adjustment parameter “x” outputted from the adjustment-parameter setting section 302, multiplies an output (D+F) of the adder 356 by “x”, and outputs the result. The multiplier 382 has a multiplier factor set to 2, multiplies an output (x(D+F)) of the multiplier 378 by 2, and outputs the result. In this way, a term of “2x(D+F)” included in equation (6) is calculated.

The adder 360 adds the output of the multiplier 374 and the output of the multiplier 380. The adder 362 adds the output of the multiplier 382 and the output of the multiplier 386. Moreover, the adder 368 adds outputs of these two adders 360 and 362. In this way, a term of “4eE+z(A+C+G+I)+2y(B+H)+2x(D+F)” included in equation (6) is calculated.

The adder 370 adds the two image quality adjustment parameters “x” and “y” outputted from the adjustment-parameter setting section 302. The adder 372 adds the output (x+y) of the adder 370 and the adjustment parameter “z” outputted from the adjustment-parameter setting section 302. The multiplier 388 has a multiplier factor set to “e”, multiplies an output (x+y+z=M) of the adder 372 by “e”, and outputs the result. The multiplier 390 has a multiplier factor set to 4, multiplies an output (eM) of the multiplier 388 by 4, and outputs the result.

The divider 392 has a divisor set to the output (4eM) of the multiplier 390, divides an output (4eE+z(A+C+G+I)+2y(B+H)+2x(D+F)) of the adder 368 by 4eM, and outputs the result. In this way, the calculation indicated by equation (6) is performed and the brightness data E″ after image quality adjustment is outputted.

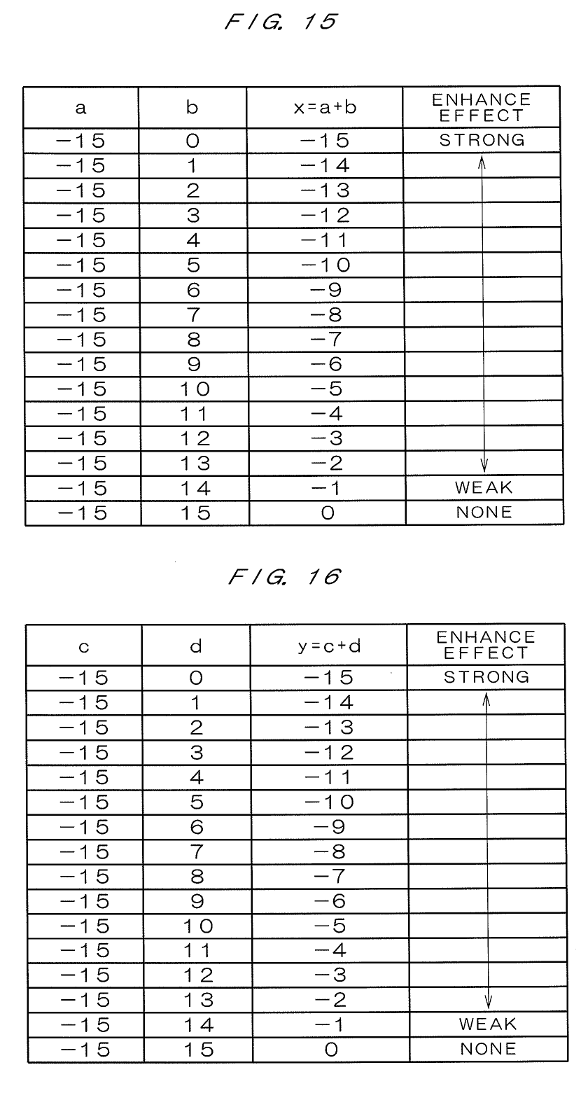

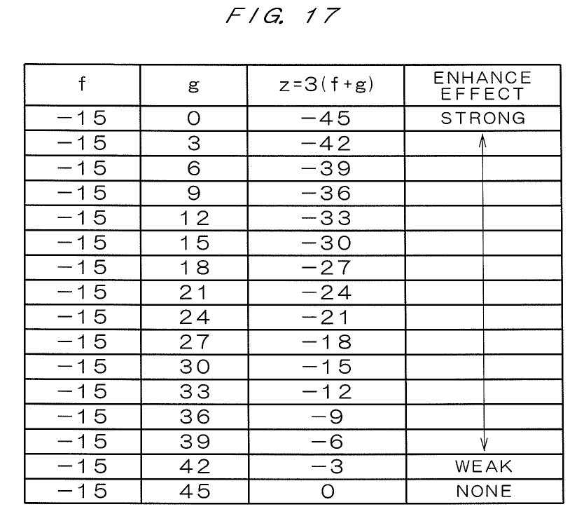

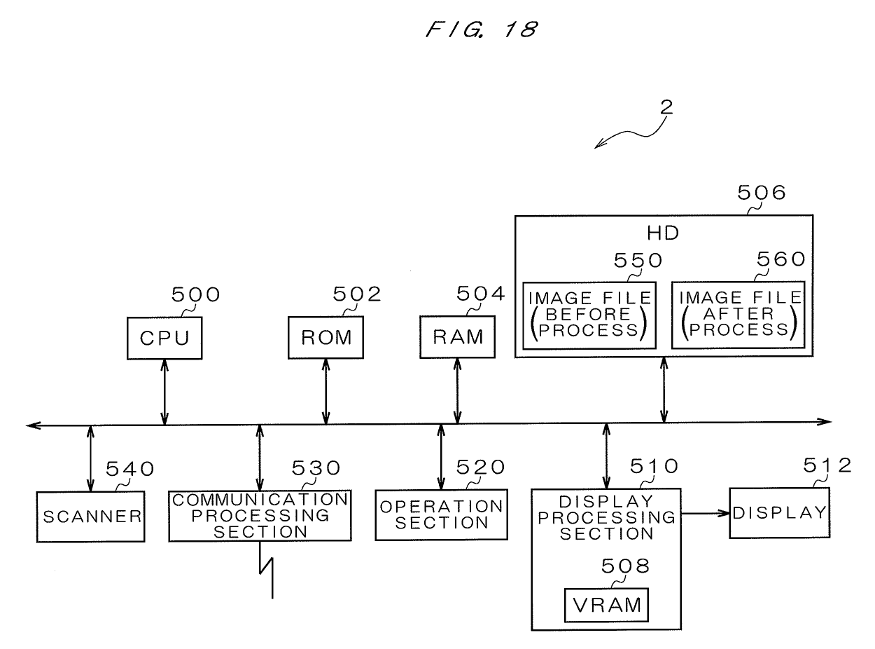

FIGS. 15, 16, and 17 are diagrams showing a relation between image quality adjustment parameters and enhance effects. An enhance effect in the horizontal direction in the case in which the image quality adjustment parameter “x” is changed is shown in FIG. 15. An enhance effect in the vertical direction in the case in which the image quality adjustment parameter “y” is changed is shown in FIG. 16. An enhance effect in oblique directions in the case in which the image quality adjustment parameter “z” is changed is shown in FIG. 17. For example, in FIGS. 8 to 10, when “e”, “a” “c” and “f” are set as e=80 and a=c=f=−15 and “b”, “d”, and “g” are changed, the image quality adjustment parameters “x”, “y”, and “z” are changed.

Concerning the horizontal direction, as shown in FIG. 15, in the case in which a value of “a” is fixed, a value (=−15) of “x” is the smallest and the enhance effect is the strongest when a value of “b” is 0. Thus, an image (brightness data) in which an edge in the vertical direction is enhanced is obtained. When the value of “b” is increased, the value of “x” increases to be close to 0 according to the increase in the value of “b”. Thus, the enhance effect weakens gradually. When the value of “b” is set to 15, the value of “x” decreases to 0 and the enhance effect is lost.

Similarly, concerning the vertical direction, as shown in FIG. 16, in the case in which a value of “c” is fixed, a value (=−15) of “y” is the smallest and the enhance effect is the strongest when a value of “d” is 0. Thus, an image (brightness data) in which an edge in the horizontal direction is enhanced is obtained. When the value of “d” is increased, the value of “y” increases to be close to 0 according to the increase in the value of “d”. Thus, the enhance effect weakens gradually. When the value of “d” is set to 15, the value of “y” decreases to 0 and the enhance effect is lost.

Concerning the oblique directions, as shown in FIG. 17, in the case in which a value of “f” is fixed, a value (=−45) of “z” is the smallest and the enhance effect is the strongest when a value of “g” is 0. Thus, an image (brightness data) in which edges in the oblique directions are enhanced is obtained. When the value of “g” is increased, the value of “z” increases to be close to 0 according to the increase in the value of “g”. Thus, the enhance effect weakens gradually. When the value of “g” is set to 45, the value of “z” decreases to 0 and the enhance effect is lost.

The line memories 320, 322, and 324 correspond to the image-data storing unit, the control circuit 334, the address generating circuit 326, the switch circuit 328, and the brightness data buffer 330 correspond to the pixel-data readout unit, the brightness-data calculating circuit 332 corresponds to the pixel-data calculating unit, and the adjustment-parameter setting section 302 corresponds to the adjustment-parameter setting unit.

As described above, in the image processing device 1 according to this embodiment, it is possible to perform the image quality adjustment processing such as edge enhancement simply by extracting nine pixels including a target pixel and calculating new pixel data corresponding to the target pixel using pixel data (brightness data and color difference data) of these nine pixels. This makes it unnecessary to perform complicated processing for, for example, performing extraction of an edge and gain adjustment and then adding the edge to original pixel data and makes it possible to simplify processing.

When pixel data of two pixels adjacent to a target pixel along an identical horizontal line (scanning line) are D and F, the image quality adjustment processing is applied to the target pixel by adding a value proportional to an added value of these pixel data D and F to the pixel data E of the target pixel. This makes it possible to perform the image quality adjustment processing with an influence due to the pixels adjacent to the target pixel in the horizontal direction reflected on pixel data of the target pixel.

When pixel data of two pixels that correspond to two horizontal lines adjacent to a target pixel and are adjacent to the target pixel in the vertical direction with respect to the horizontal lines are B and H, the image quality adjustment processing is applied to the target pixel by adding a value proportional to an added value of these pixel data B and H to the pixel data E of the target pixel. This makes it possible to perform the image quality adjustment processing with an influence due to the pixels adjacent to the target pixel in the vertical direction reflected on pixel data of the target pixel.

When pixel data of four pixels that correspond to two horizontal lines adjacent to a target pixel and are adjacent in the oblique direction with respect to the target pixel are A, C, G, and I, the image quality adjustment processing is applied to the target pixel by adding a value proportional to an added value of these pixel data A, C, G, and I to the pixel data E of the target pixel. This makes it possible to perform the image quality adjustment processing with an influence due to the pixels adjacent to the target pixel in the oblique direction reflected on pixel data of the target pixel.

By setting a proportional constant (z, 2y, and 2x in equation (6)) in calculating the value proportional to the added value to a negative value, it is possible to perform enhance processing along a direction in which the pixels to which the added value is added and the target pixel are arranged abreast. It is possible to realize an enhance effect for enhancing an edge portion included in an image.

By setting a proportional constant in calculating the value proportional to the added value to a positive value, it is possible to perform blurring processing along a direction in which the pixels to which the added value is added and the target pixel are arranged abreast. It is possible to realize a blurring effect for averaging an edge portion included in an image.

By setting the proportional constant as an adjustment parameter, a value of which is changeable, and variably setting the value of the adjustment parameter, it is possible to variably set degrees of the enhance effect and the blurring effect. In particular, simply by changing a value of the adjustment parameter, it is possible to easily obtain pixel data with the degrees of the enhance effect and the blurring effect adjusted.

When an impulse response waveform indicating an influence of the one pixel on peripheral pixels around the one pixel is used, weighting coefficients that make an influence of the one pixel different are individually set for a partial area of the peripheral pixels and for the remaining area other than the partial area by this impulse response waveform. This makes it possible to finely set a degree of the influence of the one pixel on the peripheral pixels arranged around the one pixel. In particular, a value of the weighting coefficient corresponds to a partial area close to the one pixel is set to a positive value and a value of the weighting coefficient corresponds to the remaining area distant from the one pixel is set to a negative value. This makes it possible to impart a negative area to an impulse response in the same manner as a general sampling function for performing interpolation processing among data and obtain a more natural image after image quality adjustment with the degree of the influence of the one pixel on the peripheral pixels accurately reflected thereon.

It is possible to variably set a degree of image quality adjustment by changeably setting the weighting coefficient. It is possible to individually set the impulse response waveform according to a relative positional relation of the peripheral pixels to the one pixel. This makes it possible to perform, when contents of an image have directionality (e.g., depending on a direction that an edge faces), image quality adjustment processing with the direction reflected thereon. In particular, it is possible to adjust a degree of enhancement and blurring depending on which of the horizontal, vertical and oblique directions a direction that a color and a shade of an image change is along.

### Second Embodiment

In the first embodiment described above, using the dedicated hardware, brightness data of horizontal three lines inputted in order in accordance with a scanning order is stored in order in the three line memories 320, 322, and 324 and then brightness data of 3×3 pixels having a target pixel at the center are read out to perform the image quality adjustment processing. However, the same image quality adjustment processing may be applied to image data for one screen or a part of the image data stored in a memory or the like using a computer generally used including a CPU and a memory rather than the dedicated hardware.

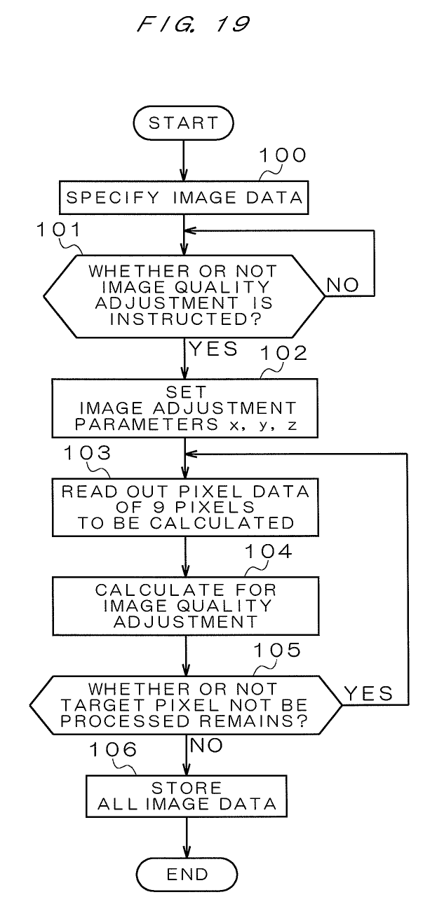

FIG. 18 is a diagram showing a configuration of an image processing device according to a second embodiment. An image processing device 2 shown in FIG. 18 includes a CPU 500, a ROM 502, a RAM 504, a hard disk device (HD) 506, a display processing section 510, a display 512, an operation section 520, a communication processing section 530, and a scanner 540. It is possible to use the computer generally used as this image processing device 2. The image processing device 2 is realized by executing an image processing program stored in the hard disk device 506, the ROM 502, or the RAM 504.

An image file 550 to be subjected to image quality adjustment processing is stored in the hard disk device 506. The image file 550 includes image data constituted by a predetermined number of pixels vertically and horizontally. For example, the image data is constituted by pixel data of RGB corresponding to each of the pixels constituting the image data. The image quality adjustment processing in this embodiment is separately applied to each of pixel data corresponding to an R component, pixel data corresponding to a G component, and pixel data corresponding to a B component. An image file 560 after the image quality adjustment processing is stored in the hard disk device 506.

The display processing section 510 has a VRAM (Video RAM) 508 corresponding to respective pixels constituting a displayed screen on the display 512. The display processing section 510 converts pixel data (RGB data) written in the VRAM 508 into a video signal of a format conforming to a display system of the display 512 and outputted in a scanning order to display an image on the display 512.

The operation section 520 is an input device that receives an operation instruction of a user and includes a keyboard and a mouse. The communication processing section 530 performs communication between the image processing device and a server and a terminal device via an external network such as the Internet. The scanner 540 reads an image drawn on a paper set thereon at predetermined resolution. An image file 550 stored in the hard disk device 506 is created by using the scanner 540. The image file 550 may be acquired using other methods without using the scanner 540. For example, an image file of a color photograph taken by a digital camera may be stored in a memory card, read it out using a card reader (not shown), and stored it in the hard disk device 506 as the image file 550. Alternatively, an image file acquired through the Internet or the like using the communication processing section 530 may be stored in the hard disk device 506 as the image file 550.

Operations in performing the image quality adjustment processing using the image processing device 2 will be explained. FIG. 19 is a flowchart showing an operation procedure of the image quality adjustment processing by the image processing device 2. An operation procedure performed by the CPU 500 that mainly executes an image processing program is shown in the figure.

After the image file 550 is specified (step 100), the CPU 500 judges whether image quality adjustment is instructed or not (step 101). For example, when the image file 550 is specified by the user and read out, contents (an image) of the image file are displayed on the display device 512. In this state, the judgment in step 101 is performed. When image quality adjustment is not instructed, negative judgment is performed and the judgment in step 101 is repeated. When the user operates the operation section 520 to instruct image quality adjustment, affirmative judgment is performed in the judgment in step 101. The CPU 500 performs setting of the image quality adjustment parameters “x”, “y”, and “z” (step 102). The user is capable of arbitrarily designating the image quality adjustment parameters “x”, “y”, and “z” in a predetermined range (e.g., in the example shown in FIGS. 15 to 17, “x” and “y” can be designated in a range of 0 to −15 and “x” can be designated in a range of 0 to −45). This designation is performed using the operation unit 520.

The CPU 500 reads out image data of 3×3 pixels including a target pixel from the entire pixel data to be subjected to the image quality adjustment processing (step 103) and performs calculation for the image quality adjustment processing indicated by equation (6) (step 104). Thereafter, the CPU 500 judges whether a target pixel not yet be processed remains or not (step 105). When a target pixel not yet be processed remains, affirmative judgment is performed. The processing returns to step 103 and the same image quality adjustment processing is repeated for the next target pixel. When a target pixel not yet be processed does not remain, negative judgment is performed in the judgment in step 105. Image data after the image quality judgment processing corresponding to all target pixels is stored as the image file 560 (step 106) and the series of processing ends.

The invention is not limited to the embodiments. Various modifications are possible within the scope of the gist of the invention. For example, in the first embodiment, the case in which video data of a format conforming to ITU-R.BT601-5/656 is inputted is explained. However, it is possible to perform image quality adjustment processing in the same manner even if it is an image data of other formats as long as a video signal is inputted in a scanning order. RGB data may be inputted in the scanning order or shadow data for a white and black video may be inputted rather than brightness data and color difference data. In the case of the RGB data, pixel data of an R component, pixel data of a G component, and pixel data of a B component are separated in the same manner as the case of brightness data and color difference data to separately perform the image quality adjustment processing. Conversely, in the second embodiment, the image quality adjustment processing is applied to an image file including RGB data. However, the image quality adjustment processing may be applied to the image file including brightness data, color difference data, or shade data.

In the embodiments described above, the enhance effect is obtained by setting values of the image quality adjustment parameters “x”, “y”, and “z” to negative values. However, values of these image quality adjustment parameters “x”, “y”, and “z” may be set to positive values. When these values are set to positive, an effect for blurring an image is obtained instead of the enhance effect.

In the embodiments described above, the image quality adjustment parameters “x” and “y” are set separately. However, when the enhance effects in the horizontal direction and the vertical direction are set the same, these two image quality adjustment parameters “x” and “y” may be set the same. In this case, another adder only has to be inserted at a pre-stage of the multiplier 376 and the multiplier 378 shown in FIG. 14 to sum up the outputs of the adders 354 and 356 and then input an output of the inserted adder to the multiplier 376 (or the multiplier 378). Consequently, it is possible to omit the multiplier 378 (or the multiplier 376), which is not used, and the multiplier 382 (or the multiplier 380) at a post-stage thereof.

In the embodiments described above, degrees of influences of one pixel on eight pixels arranged around the one pixel are as shown in FIG. 7. However, the degrees of the influences may be changed. For example, for a degree of an influence in oblique directions, a weighting coefficient is set as “g” for ¼ areas close to a center pixel and a weighting coefficient is set as “f” for ¾ areas other than the ¼ areas. However, a weighting coefficient may be set as “g” for ¾ areas close to the center pixel and a weighting coefficient may be set as “f” for ¼ areas other than the ¾ areas. Alternatively, a weighting coefficient may be set as g for ½ areas in the vertical direction on a side close to the center pixel and a weighting coefficient may be set as “f” for ½ areas other than the ½ areas in the vertical direction. A weighting coefficient may be set as “g” for ½ areas in the horizontal direction on a side close to the center pixel and a weighting coefficient may be set as “f” for ½ areas other than the ½ areas in the horizontal direction.

### INDUSTRIAL APPLICABILITY

According to the invention, it is possible to perform image quality adjustment processing such as edge enhancement simply by extracting nine pixels including a target pixel and calculating new pixel data corresponding to the target pixel using pixel data of these nine pixels. This makes it unnecessary to perform complicated processing for, for example, performing extraction of an edge and gain adjustment and then adding the edge to original image data and makes it possible to simplify processing.

1. An image processing device comprising:
an image-data storing unit that stores image data including pixel data of a plurality of pixels constituting an image;
a pixel-data readout unit that reads out pixel data of a total of nine pixels, 3×3 pixels having a target pixel at a center of said nine pixels from among the image data stored in the image-data storing unit; and
a pixel-data calculating unit that calculates new image data after image quality adjustment is performed corresponding to the target pixel with using the image data of the nine pixels read out by the pixel-data readout unit.

2. The image processing device according to claim 1, wherein, when pixel data of two first pixels adjacent to a target pixel along an identical horizontal line are D and F, the pixel-data calculating unit applies image quality adjustment processing to the target pixel by adding a value proportional to an added value of these pixel data D and F to pixel data E of the target pixel.

3. The image processing device according to claim 2, wherein enhance processing along a direction in which the pixels to which the added value is added and the target pixel are arranged abreast is performed by setting a proportional constant in calculating the value proportional to the added value to a negative value.

4. The image processing device according to claim 3, wherein the proportional constant is an adjustment parameter, a value of which is changeable, and the image processing device further includes an adjustment-parameter setting unit that variably sets the value of the adjustment parameter.

5. The image processing device according to claim 4, wherein the pixel-data calculating unit adjusts values of the pixel data for the image quality adjustment according to the value of the adjustment parameter set by the adjustment-parameter setting unit.

6. The image processing device according to claim 2, wherein blurring processing along a direction in which the pixels to which the added value is added and the target pixel are arranged abreast is performed by setting a proportional constant in calculating the value proportional to the added value to a positive value.

7. The image processing device according to claim 6, wherein the proportional constant is an adjustment parameter, a value of which is changeable, and the image processing device further includes an adjustment-parameter setting unit that variably sets the value of the adjustment parameter.

8. The image processing device according to claim 7, wherein the pixel-data calculating unit adjusts values of the pixel data for the image quality adjustment according to the value of the adjustment parameter set by the adjustment-parameter setting unit.

9. The image processing device according to claim 1, wherein, when pixel data of two second pixels that correspond to two horizontal lines adjacent to the target pixel and are adjacent to the target pixel in the vertical direction with respect to the horizontal lines are B and H, the pixel-data calculating unit applies image quality adjustment processing to the target pixel by adding a value proportional to an added value of these pixel data B and H to pixel data E of the target pixel.

10. The image processing device according to claim 9, wherein enhance processing along a direction in which the pixels to which the added value is added and the target pixel are arranged abreast is performed by setting a proportional constant in calculating the value proportional to the added value to a negative value.

11. The image processing device according to claim 10, wherein the proportional constant is an adjustment parameter, a value of which is changeable, and the image processing device further includes an adjustment-parameter setting unit that variably sets the value of the adjustment parameter.

12. The image processing device according to claim 11, wherein the pixel-data calculating unit adjusts values of the pixel data for the image quality adjustment according to the value of the adjustment parameter set by the adjustment-parameter setting unit.

13. The image processing device according to claim 9, wherein blurring processing along a direction in which the pixels to which the added value is added and the target pixel are arranged abreast is performed by setting a proportional constant in calculating the value proportional to the added value to a positive value.

14. The image processing device according to claim 13, wherein the proportional constant is an adjustment parameter, a value of which is changeable, and the image processing device further includes an adjustment-parameter setting unit that variably sets the value of the adjustment parameter.

15. The image processing device according to claim 14, wherein the pixel-data calculating unit adjusts values of the pixel data for the image quality adjustment according to the value of the adjustment parameter set by the adjustment-parameter setting unit.

16. The image processing device according to claim 1, wherein, when pixel data of four third pixels that correspond to two horizontal lines adjacent to the target pixel and are adjacent to the target pixel in oblique directions are A, C, G, and I, the pixel-data calculating unit applies image quality adjustment processing to the target pixel by adding a value proportional to an added value of these pixel data A, C, G, and I to pixel data E of the target pixel.

17. The image processing device according to claim 16, wherein enhance processing along a direction in which the pixels to which the added value is added and the target pixel are arranged abreast is performed by setting a proportional constant in calculating the value proportional to the added value to a negative value.

18. The image processing device according to claim 17, wherein the proportional constant is an adjustment parameter, a value of which is changeable, and the image processing device further includes an adjustment-parameter setting unit that variably sets the value of the adjustment parameter.

19. The image processing device according to claim 18, wherein the pixel-data calculating unit adjusts values of the pixel data for the image quality adjustment according to the value of the adjustment parameter set by the adjustment-parameter setting unit.

20. The image processing device according to claim 16, wherein blurring processing along a direction in which the pixels to which the added value is added and the target pixel are arranged abreast is performed by setting a proportional constant in calculating the value proportional to the added value to a positive value.

21. The image processing device according to claim 20, wherein the proportional constant is an adjustment parameter, a value of which is changeable, and the image processing device further includes an adjustment-parameter setting unit that variably sets the value of the adjustment parameter.

22. The image processing device according to claim 21, wherein the pixel-data calculating unit adjusts values of the pixel data for the image quality adjustment according to the value of the adjustment parameter set by the adjustment-parameter setting unit.

23. The image processing device according to claim 1, wherein the pixel-data calculating unit multiplies pixel data of one pixel by a weighting coefficient indicated by an impulse response waveform indicating an influence of the one pixel on peripheral pixels around the one pixel and calculates new pixel data corresponding to the target pixel by associating an influence of the adjacent pixels on the target pixel with the one pixel, and the weighting coefficients that make the influences of the one pixel on the peripheral pixels different are individually set for a partial area of the peripheral pixels and for a remaining area other than the partial area by the impulse response waveform.

24. The image processing device according to claim 23, wherein, as the weighting coefficient, a positive value is set in association with the partial area close to the one pixel and a negative value is set in association with the remaining area distant from the one pixel.

25. The image processing device according to claim 23, further comprising a weighting-coefficient setting unit that variably sets the weighting coefficient.

26. The image processing device according to claim 25, wherein it is possible to individually set the impulse response waveform according to a relative positional relation of the peripheral pixels to the one pixel.

27. The image processing device according to claim 26, wherein it is possible to individually set the weighting coefficient indicated by the impulse response waveform for a case in which the peripheral pixels are adjacent to the one pixel along a horizontal line, a case in which the peripheral pixels are adjacent to the one pixel in the vertical direction with respect to the horizontal line, and a case in which the peripheral pixels are adjacent to the one pixel in oblique directions with respect to the horizontal line.

28. An image processing method comprising:
a step of reading out pixel data of a total nine pixels, 3×3 pixels having a target pixel at a center of said nine pixels, from among the image data including pixel data of a plurality of pixels constituting an image; and
a step of calculating new pixel data after image quality adjustment is performed corresponding to the target pixel with using the pixel data of the nine pixels read out.

29. The image processing method according to claim 28, wherein, when pixel data of two first pixels adjacent to a target pixel along an identical horizontal line are D and F, in the step of calculating new pixel data, image quality adjustment processing is applied to the target pixel by adding a value proportional to an added value of these pixel data D and F to pixel data E of the target pixel.

30. The image processing method according to claim 29, wherein enhance processing along a direction in which the pixels to which the added value is added and the target pixel are arranged abreast is performed by setting a proportional constant in calculating the value proportional to the added value to a negative value.

31. The image processing method according to claim 30, wherein the proportional constant is an adjustment parameter of which value is changeable, further comprising a step of variably setting the value of the adjustment parameter.

32. The image processing method according to claim 29, wherein blurring processing along a direction in which the pixels to which the added value is added and the target pixel are arranged abreast is performed by setting a proportional constant in calculating the value proportional to the added value to a positive value.

33. The image processing method according to claim 32, wherein the proportional constant is an adjustment parameter of which value is changeable, further comprising a step of variably setting the value of the adjustment parameter.

34. The image processing method according to claim 28, wherein, when pixel data of two second pixels that correspond to two horizontal lines adjacent to the target pixel and are adjacent to the target pixel in the vertical direction with respect to the horizontal lines are B and H, in the step of calculating new pixel data, image quality adjustment processing is applied to the target pixel by adding a value proportional to an added value of these pixel data B and H to pixel data E of the target pixel.

35. The image processing method according to claim 34, wherein enhance processing along a direction in which the pixels to which the added value is added and the target pixel are arranged abreast is performed by setting a proportional constant in calculating the value proportional to the added value to a negative value.

36. The image processing method according to claim 35, wherein the proportional constant is an adjustment parameter of which value is changeable, further comprising a step of variably setting the value of the adjustment parameter.

37. The image processing method according to claim 34, wherein blurring processing along a direction in which the pixels to which the added value is added and the target pixel are arranged abreast is performed by setting a proportional constant in calculating the value proportional to the added value to a positive value.

38. The image processing method according to claim 37, wherein the proportional constant is an adjustment parameter of which value is changeable, further comprising a step of variably setting the value of the adjustment parameter.

39. The image processing method according to claim 28, wherein, when pixel data of four third pixels that correspond to two horizontal lines adjacent to the target pixel and are adjacent to the target pixel in oblique directions are A, C, G, and I, in the step of calculating new pixel data, image quality adjustment processing is applied to the target pixel by adding a value proportional to an added value of these pixel data A, C, G, and I to pixel data E of the target pixel.

40. The image processing method according to claim 39, wherein enhance processing along a direction in which the pixels to which the added value is added and the target pixel are arranged abreast is performed by setting a proportional constant in calculating the value proportional to the added value to a negative value.

41. The image processing method according to claim 40, wherein the proportional constant is an adjustment parameter of which value is changeable, further comprising a step of variably setting the value of the adjustment parameter.

42. The image processing method according to claim 39 wherein blurring processing along a direction in which the pixels to which the added value is added and the target pixel are arranged abreast is performed by setting a proportional constant in calculating the value proportional to the added value to a positive value.

43. The image processing method according to claim 42, wherein the proportional constant is an adjustment parameter of which value is changeable, further comprising a step of variably setting the value of the adjustment parameter.
